(19) United States
(12) Patent Application Publication
(10) Pub. No.: US 2018/0045094 A1
(43) Pub. Date: Feb. 15, 2018

(54) SYSTEM AND METHOD FOR AUTOMOTIVE FLUIDS MANAGEMENT AND MAINTENANCE SYSTEM (AFMMS)

(71) Applicant: Khalid Mike Allos, Lakeside, CA (US)

(72) Inventor: Khalid Mike Allos, Lakeside, CA (US)

(21) Appl. No.: 15/677,778

(22) Filed: Aug. 15, 2017

Related U.S. Application Data
(60) Provisional application No. 62/375,032, filed on Aug. 15, 2016.

(51) Int. Cl. F01M 11/04; F01P 11/06; F01M 1/22; F01P 11/02

(52) U.S. Cl. CPC F01M 11/0458; F01P 11/0276; F01P 11/06; F01M 1/22; B67D 7/46

(57) ABSTRACT

Systems and methods disclosed provide an automotive fluids management and maintenance system (AFMMS) that manages and maintains fluids within vehicles by accurately and in a controlled manner directing the propulsion of these fluids into vehicle's internal components and also accurately and in a controlled manner draining fluids out of vehicle's internal components. The systems and methods enable a technician to dispense any desired fluid and pump the same into a vehicle internal component with speed, efficiency, accuracy, and in a very clean and unwasteful manner. The AFMMS is powered by a standard shop air supply. Once charged with air pressure, the AFMMS becomes mobile and is without any attachments, e.g., to a wall air supply, thus making it safe and convenient to be used around any shop environment, as well as outside in parking lots.

### CROSS-REFERENCE TO RELATED APPLICATIONS

This application claims benefit of priority of U.S. provisional Patent Application Ser. No. 62/375,032, filed Aug. 15, 2016, entitled “AUTOMOTIVE FLUIDS MANAGEMENT AND MAINTENANCE SYSTEM”, which is incorporated by reference in its entirety.

### FIELD

The invention relates to automotive fluids.

### BACKGROUND

Vehicle manufacturers are continuously changing their designs based on market demands. Some of these changes are making car repair and maintenance more challenging. Even normal routine service that requires the technician to replace fluids and lubricants can be challenging

Traditionally on old cars, to service a vehicle transmission, the technician will drain the fluid from the fluid pan and refill it from the top via a dipstick tube using a funnel.

However, today, many newer cars do not have a filling tube; instead, the manufacturer procedure requires the vehicle be lifted and, e.g., transmission fluid, be pumped into the transmission pan via a drain plug/over a flow tube combination. The engine is then started and warmed up to the normal operating temperature while continuing to fill the transmission to its recommended level and, of course, not over filling it.

This procedure is difficult, lengthy, time consuming, requires two technicians, and causes a significant amount of wasted fluid. In many cases a mess is caused due to dumping of excess fluid charged into the transmission. This technique thus has significant deficiencies that reduce productivity for the shop. It also increases the shop expense because of wasted material and wasted time of the technician who has to clean up the spilled fluid.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

Systems and methods according to present principles meet the needs of the above in several ways.

In one aspect, the invention is directed to a system that manages and controls the propulsion of fluids into vehicles' internal components and drains fluids from vehicles' internal components, including: a movable housing; a rechargeable air tank disposed securely to the movable housing; a plurality of containers for fluid disposed securely to the movable housing; a manifold coupled to an outlet of the rechargeable air tank and fluidically coupled to each of the plurality of containers for fluid to selectively exert air pressure within a portion of one or more of the plurality of containers, and in particular to a portion of an interior of a respective one or more of the plurality of containers, the portion not occupied by fluid.

Implementations of the invention may include one or more of the following. The plurality of containers may house respective multiple fluids for a provision of respective fluids into one or more of a vehicle's internal components and for draining fluid from a respective one or more of a vehicle's internal components. Each of the plurality of containers may be a transparent tube that provides a visibility of fluid colors, types and rate of displacement. The fluids may include one or more of cooling fluids, lubricants and hydraulic fluids for power steering, active suspensions, power tops and power tail gates or trunks. The system may further include at least two flexible hoses and one fluid coupler for the transfer of fluids. The fluid coupler may be an off-centered fluid coupler between the at least two flexible hoses to allow for maneuvering of the flexible hoses and re-storage of hoses onto a rack and to prevent kinking. The rechargeable air tank may store compressed air. The system may further include a valve on the rechargeable air tank structured and configured to mate with a standard automotive repair shop compressed air supply. The system may further include a regulator valve configured to regulate the automotive shop repair compressed air supply from around 120 psi to a lower psi to accommodate a desired pressure by a technician. The system may further include a respective filler cap for each of the transparent tubes that house fluids that are being transferred to the internal components for quickly refilling. The filler cap may include a plurality of built-in pressure relief channels within the filler cap itself or incorporates grooves that act as relief channels. The filler cap may be structured in configured to activate pressure relief channels automatically as the filler cap is turned anticlockwise to be loosened and pulled out. The system may further include one or more multiple dedicated three way valves that prevent fluid cross contamination. The system may further include multiple dedicated three way valves for the propulsion of each fluid, such that each container is associated with its own 3-way valve, and such that the valves are configured to propel fluids into vehicle's internal components and to drain excess fluids from vehicles' internal components in a controlled manner.

In another aspect, the invention is directed towards a method method of controllably directing fluids into automotive components, including: charging the air cylinder in 1 with compressed air; coupling a distal end of a flexible hose to an inlet of an automotive internal component; coupling the proximal end of the flexible hose to an outlet of the manifold causing pressurized air to enter the portion of the container not occupied by fluid; such that pressurized fluid is directed into the vehicle internal component.

In another aspect, the invention is directed towards a fluid coupler, including: a first portion and a second portion, the first portion including a fluid inlet and the second portion including a fluid outlet; a hollow plug component on one of the first portion or the second portion, the plug component mateably engaging a hole component on the other of the first portion or the second portion, such that the first portion can rotate relative to the second portion when a set screw is not engaged in a set screw hole; one or more O-rings on the plug component, the one or more O-rings serving to seal against fluid egress; such that fluids entering the fluid inlet pass through the hollow plug component and exit the fluid outlet.

Advantages of the invention may include, in certain embodiments, one or more of the following. Systems and methods according to present principles allow a technician to install fluids on any car. Systems and methods allow a portable device in which a single compressed air cylinder can be coupled and provide pressure to numerous fluid containers at one time, greatly increasing the efficiency and effectiveness of the device. Other advantages will be understood from the description that follows, including the figures and claims.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

### BRIEF DESCRIPTION OF THE DRAWINGS

FIG. 1 is a side view of an automotive fluid management and maintenance system according to one implementation of present principles.

FIG. 2 is a top view of the automotive fluid management and maintenance system according to one implementation of present principles.

FIG. 3 is a perspective view of an assembled fluid coupler according to present principles.

FIG. 4 is an exploded view of the fluid coupler according to present principles.

FIG. 5 is a front perspective view of the automotive fluid management and maintenance system according to an implementation of present principles.

FIG. 6 is a rear perspective view of the automotive fluid management and maintenance system according to an implementation of present principles.

Like reference numerals refer to like elements throughout. Elements are not to scale unless otherwise noted.

### DETAILED DESCRIPTION

In one implementation, systems and methods according to present principles provide an automotive fluids management and maintenance system (AFMMS) that manages and maintains fluids within vehicles by accurately and in a controlled manner directing the propulsion of these fluids into vehicle's internal components and also accurately and in a controlled manner draining fluids out of vehicle's internal components.

The unique and customized design of AFMMS enables the technician to dispense any desired fluid and pump the same into a vehicle internal component with speed, efficiency, accuracy, and in a very clean and unwasteful manner. The AFMMS is powered by a standard shop air supply. Once charged with air pressure, the AFMMS becomes mobile and is without any attachments, e.g., to a wall air supply, thus making it safe and convenient to be used around any shop environment, as well as outside in parking lots.

AFMMS can be made from steel or aluminum or other metals that make up the structural components and the air pressure storage tank.

In one implementation, the tank is located in the center and is mounted on a base that houses the wheels and or casters around the tank and attached to it there are multiple tubes, which may be transparent, made from impact resistant polycarbonate or other material. The tubes will be filled with the desired fluid that needs to be dispensed. Then regulated air pressure from a calibrated pressure manifold is applied to one or more of the tubes allowing the fluids to be displaced out the tube via a hose to a dispensing valve with bi-directional controls for causing a filling function and a calibration function.

The AFMMS may be implemented as a a self-contained unit that carries the desired fluids to be installed on vehicles as well as the means to deliver them as a mobile stand-alone unit.

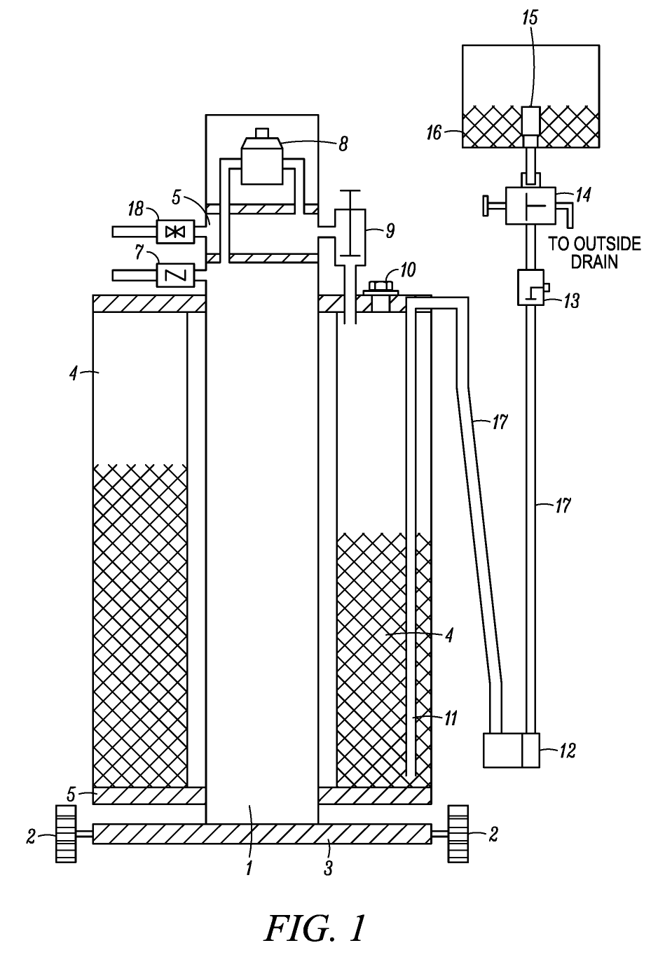

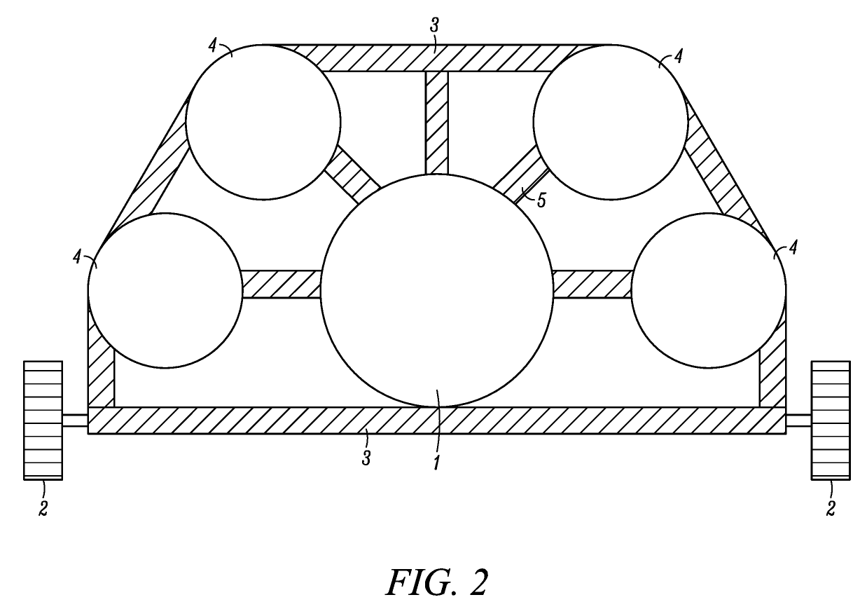

The following is a components list that describes elements on FIGS. 1-2:

### COMPONENTS LIST

1. Air Pressure Storage
2. Wheels
3. Main Frame
4. Fluid Cells
5. Fluid Cells Bracket
6. Regulated Pressure Chamber
7. Air Charge Inlet Check Valve
8. Air Pressure Regulator
9. Manual Valve “ON & OFF”
10. Filler Cap
11. Pick-Up Tube
12. Fluid Coupler
13. Manual Valve “Momentary”
14. Manual Valve “Three Way”
15. Overflow Tube
16. Vehicle Transmission Pan or Sump
17. Flexible Hose
18. Pressure Relief Valve

The AFMMS operational procedure is initiated by filling an air pressure storage tank (1) through an air charge inlet check valve (7). The source for filling the air pressure storage tank may be a standard air supply hose in auto repair shops. The air pressure storage tank is pressurized until it reaches full capacity which means it has reached an equilibrium with the pressure of the source. Air supply is approximately 120 psi in auto repair shops which would mean the equilibrium in the air, pressure storage tank would also be 120 psi. Once equilibrium is reached the air supply hose is disconnected and the AFMMS is now a fully charged and mobile unit.

The pressurized air from storage tank (1) is connected to air pressure regulator (8). Air pressure regulator (8) regulates and drops the air pressure to the desired level preferred by the technician which is approximately 10 psi to 30 psi for safety reasons. The air pressure is regulated to a level that is appropriate for the viscosity of the fluid being used and is regulated to achieve the desired speed of flow for the specific fluid being used. As noted if desired a cap level of pressure may be employed, e.g., 30 psi.

The regulated air pressure coming out of regulator (8) enters chamber (6) which acts as the manifold that distributes air pressure to each individual fluid cells (4) (all fluid cells are labelled as (4) but they each contain different fluids). The regulated air enters one of the cells (4) via a manual valve (9).

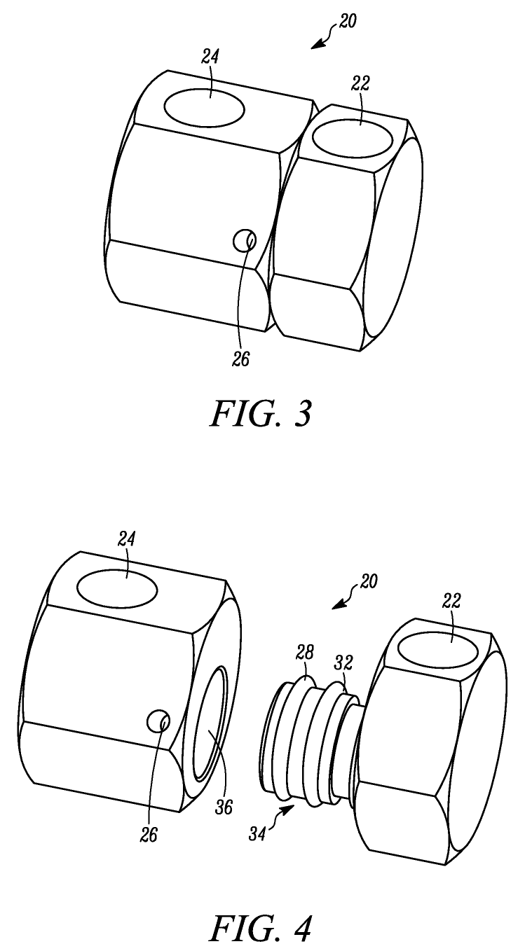

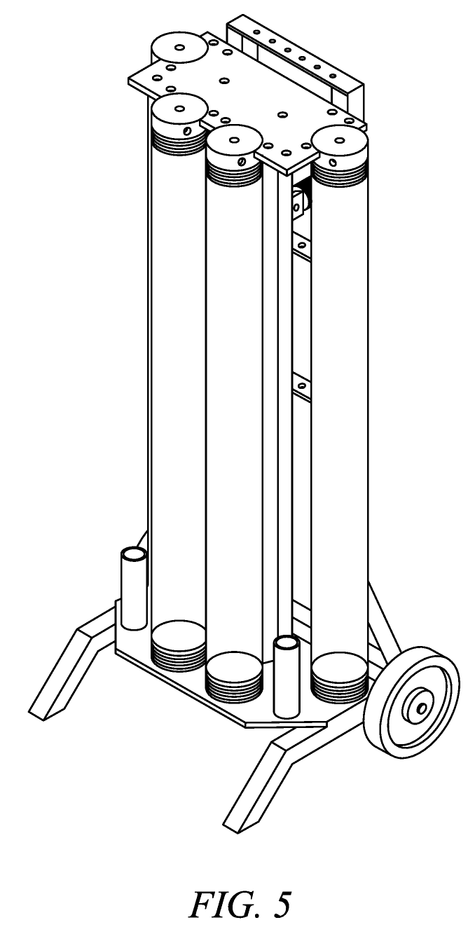

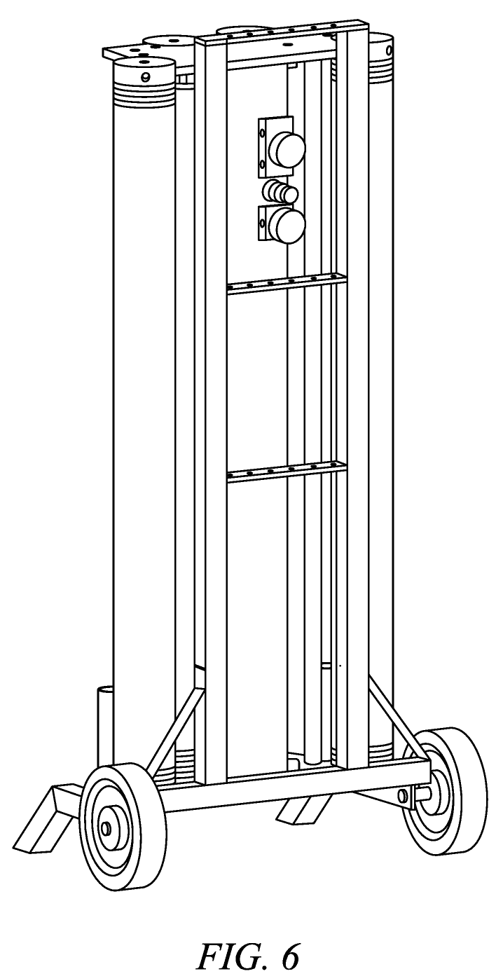

In order to fill any of the cells (4) the technician may first close valve (9). The technician then opens filler cap (10) fills the cell (4) with the desired fluid and the desired amount. After that, the technician closes the filler cap (10). Once filler cap (10) is closed the technician opens valve (9) and allows the regulated/pressurized air to fill and pressurize the cell (4). Once cell (4) is pressurized, it is ready to propel fluid through pick up tube (11) via two flexible hoses (17) that are attached by a fluid coupler (12). Fluid coupler (12) allows for easy and convenient maneuvering of flexible hoses (17) as well as reaching to the desired connection at the vehicle. Fluid coupler (12) also allows for convenient and tangle-free movement of hoses (17) and the hanging of hoses (17) back onto the rack of the AFMMS. The fluid coupler is described in greater detail in FIGS. 3-4.

The fluid travels through hoses (17) and to Manual Valve “Momentary” (13). For safety purposes, Manual Valve “Momentary” (13), when released, interrupts and cuts off fluid flow though the Manual Valve “Three Way” (14). Manual Valve “Three Way” (14) is bidirectional and is used to direct fluid flow to fluid pan (16) in one direction and then when turned 90 degrees, the Manual Valve “Three Way” will drain fluid from fluid pan (16) to the outside drain thus ensuring the correct amount of fluid is being drained. The result is an accurate, easy and clean achievement of the desired level of fluid in fluid pan (16).

Details of the fluid coupler are illustrated in FIGS. 3-4. As may be seen, the fluid coupler includes a first portion (right side) and a second portion (left side). The first portion includes a fluid inlet 22 in the second portion includes a fluid outlet 24. A hollow plug component 34 is provided, the hollow plug component capable of being mounted on either the first portion or the second portion, and in FIG. 4 is illustrated as being mounted on the first portion. The hollow plug component mateably engages a hole component 36 on the other of the first portion or the second portion, such that the first portion can rotate relative to the second portion when a set screw is not engaged in a set screw hole 26. One or more O-rings 28 and 32 may be disposed on the plug component to serve to seal against fluid egress. In this way, fluids entering the fluid inlet pass through the hollow plug component and exited the fluid outlet, while allowing the first portion to rotate relative to the second portion. As may be seen in the figures, the hollow plug component may be axially offset from the geometric axis of the components, and the same can lead to various benefits.

The following types of fluids may be managed by the AFMMS: Lubricants—Transmission, Engine, Differentials, Gearboxes; Hydraulics—Hydraulic Fluids, Power Steering, Transmissions, Power Soft or Hardtops; Coolants—Cooling system with different colors, windshield washer fluid.

### Special Automotive Application of the AFMMS

A segment of vehicles that do not have the means to be filled with fluids for repair and maintenance purposes using conventional methods and relying on gravity feed thru a filler cap or dipstick tube using a funnel. AFMMS allows a technician to install fluids on any car.

It will be appreciated that elements or components shown with any embodiment herein are merely exemplary for the specific embodiment and may be used on or in combination with other embodiments disclosed herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A system that manages and controls the propulsion of fluids into vehicles' internal components and drains fluids from vehicles' internal components, comprising:
a movable housing;
a rechargeable air tank disposed securely to the movable housing;
a plurality of containers for fluid disposed securely to the movable housing;
a manifold coupled to an outlet of the rechargeable air tank and fluidically coupled to each of the plurality of containers for fluid to selectively exert air pressure within a portion of one or more of the plurality of containers, and in particular to a portion of an interior of a respective one or more of the plurality of containers, the portion not occupied by fluid.

2. The system of claim 1 wherein the plurality of containers house respective multiple fluids for a provision of respective fluids into one or more of a vehicle's internal components and for draining fluid from a respective one or more of a vehicle's internal components.

3. The system of claim 2 wherein each of the plurality of containers is a transparent tube that provides a visibility of fluid colors, types and rate of displacement.

4. The system of claim 3 wherein the fluids include one or more of cooling fluids, lubricants and hydraulic fluids for power steering, active suspensions, power tops and power tail gates or trunks.

5. The system of claim 4, further comprising at least two flexible hoses and one fluid coupler for the transfer of fluids.

6. The system of claim 5, wherein the fluid coupler is an off-centered fluid coupler between the at least two flexible hoses to allow for maneuvering of the flexible hoses and re-storage of hoses onto a rack and to prevent kinking.

7. The system of claim 1, wherein the rechargeable air tank stores compressed air.

8. The system of claim 7, further including a valve on the rechargeable air tank structured and configured to mate with a standard automotive repair shop compressed air supply.

9. The system of claim 8, further comprising a regulator valve configured to regulate the automotive shop repair compressed air supply from around 120 psi to a lower psi to accommodate a desired pressure by a technician.

10. The system of claim 2 further comprising a respective filler cap for each of the transparent tubes that house fluids that are being transferred to the internal components for quickly refilling.

11. The system of claim 10, wherein the filler cap includes a plurality of built-in pressure relief channels within the filler cap itself or incorporates grooves that act as relief channels.

12. The system of claim 11, wherein the filler cap is structured in configured to activate pressure relief channels automatically as the filler cap is turned anticlockwise to be loosened and pulled out.

13. The system of claim 2, further comprising one or more multiple dedicated three way valves that prevent fluid cross contamination.

14. The system of claim 2, further comprising multiple dedicated three way valves for the propulsion of each fluid, such that each container is associated with its own 3-way valve, and such that the valves are configured to propel fluids into vehicle's internal components and to drain excess fluids from vehicles' internal components in a controlled manner.

15. A method of controllably directing fluids into automotive components, comprising:
charging the air cylinder in the system of claim 1 with compressed air;
coupling a distal end of a flexible hose to an inlet of an automotive internal component;
coupling the proximal end of the flexible hose to an outlet of the manifold causing pressurized air to enter the portion of the container not occupied by fluid;
such that pressurized fluid is directed into the vehicle internal component.

16. A fluid coupler, comprising:
a first portion and a second portion, the first portion including a fluid inlet and the second portion including a fluid outlet;
a hollow plug component on one of the first portion or the second portion, the plug component mateably engaging a hole component on the other of the first portion or the second portion, such that the first portion can rotate relative to the second portion when a set screw is not engaged in a set screw hole;
one or more O-rings on the plug component, the one or more O-rings serving to seal against fluid egress;
such that fluids entering the fluid inlet pass through the hollow plug component and exit the fluid outlet.
